(19) United States
(12) Patent Application Publication
(10) Pub. No.: US 2005/0186467 A1
(43) Pub. Date: Aug. 25, 2005

(54) Electrode for polymer electrolyte fuel cell

(75) Inventor: Mikio Sugiura, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/056,244

(22) Filed: Feb. 14, 2005

(30) Foreign Application Priority Data
Feb. 23, 2004 (JP) 2004-046818

(51) Int. Cl. H01M 4/86; H01M 8/10

(52) U.S. Cl. 429/42; 429/30

(57) ABSTRACT

An electrode for a polymer electrolyte fuel cell includes a polymer electrolyte membrane, and a catalyst layer provided at at least one side of the polymer electrolyte membrane. The catalyst layer is manufactured by application of a catalyst paste. The catalyst paste contains an electrolytic solution, in which electrolytes of different equivalent weights (EWs) are dissolved, or dispersed, and which the electrolytic solution is dissolved, or dispersed in a dispersing medium and a particle supporting a catalyst having electric conductivity, also dissolved, or dispersed, in the dispersing medium. The catalyst paste is manufactured by blending and dispersing an electrolytic solution in which an electrolyte of a low EW is dissolved, or dispersed, into the dispersing medium to a high level of dispersion, and blending and dispersing an electrolytic solution in which an electrolyte of a high EW is dissolved, or dispersed, into the dispersion medium to a low level of dispersion.

### CROSS REFERENCE TO RELATED APPLICATIONS

This application is based on and claims priority under 35 U.S.C. § 119 to Japanese Patent Application 2004-046818, filed on Feb. 23, 2004, the entire content of which is incorporated herein by reference.

### FIELD OF THE INVENTION

This invention generally relates to an electrode for a polymer electrolyte fuel cell. More particularly, this invention generally relates to an electrode for a polymer electrolyte fuel cell having a catalyst layer provided on a polymer electrolyte membrane.

### BACKGROUND

Recently, fuel cells are being intensively developed. There are various kinds of fuel cell. For vehicles, or for systems for electric generation, a polymer electrolyte fuel cell is now being developed.

In the polymer electrolyte fuel cell, electric energy is generated by means of an electrolysis reaction of hydrogen and oxygen as follows.

Electrode of fuel cell side: H₂→2H⁺+2e⁻

Electrode of air side: 2H⁺+1/2O₂+2e⁻→H₂O

Entire reaction: H₂+1/2O₂→H₂O

Generally, an electrode membrane assembly is structured by forming catalyst layers having a catalytic metal on both sides of a polymer electrolyte membrane, and by bonding a gas diffusion layer to each catalyst layer.

The fuel cell is structured by sandwiching the membrane electrode assembly by a separator having a gas flowing path. The membrane electrode assembly is structured by forming catalyst layers having a catalytic metal on both sides of the polymer electrolyte membrane, and by bonding a gas diffusion layer to each catalyst layer, by means of a separator having a gas flowing path. With the use of a polymer electrolyte fuel cell, electricity is generated by supplying air that contains oxygen to an electrode to which air is supplied, and by supplying hydrogen to an electrode to which fuel is supplied. It is assumed that the electrolytic reaction described above takes place at a three-phase boundary surface where a catalyst, electrolyte, and gas are located. In other words, if the number of three-phase boundary surfaces is small, the number of locations for the electrolytic reaction mentioned above becomes small, and the performance of the fuel cell is accordingly degraded.

The catalyst layer is formed as follows. A catalyst paste is formed by mixing carbon particles supporting catalyst particles such as platinum (Pt) on surfaces of the carbon particles, an electrolyte including an ion-conductive polymer and a solvent. The catalyst paste is applied to a polymer electrolyte membrane, and is then dried. The catalyst paste can also be formed by being applied onto a fluorocarbon resin film, and then dried. In either case, the dried catalyst paste is then bonded to the polymer electrolyte membrane.

Increasing a level of dispersion is one of the methods utilized for increasing the number of three-phase boundary surfaces in the catalyst layer. For increasing a level of dispersion in the catalyst layer, a change of dispersion method, or a change in a dispersion medium are two of the methods used. As dispersing methods, a homogenizing method according to which a homogenizer such as a ball mill with media is used, a homogenizing method in which ultrasonic is used, and a homogenizing method by use in which a jet mill is used, are all possible.

However, when any of these methods are used, an increase in the level of dispersion is limited. Moreover, when it is intended to increase the level of dispersion by increasing the amount of the dispersion medium, an extreme decrease in viscosity is also induced.

In order to enhance the level of dispersion, JP2003-45440A, JP2003-45437A, and JP2003-77479A propose the use of a dispersing agent. By use of the dispersing agent, enhancement of the level of dispersion was achieved. However, the dispersing agent remains in the catalyst layer manufactured, and the dispersing agent remaining interferes with the generation of the three-phase boundary surface. As a result, a satisfactory performance of the fuel cell was not obtained.

Furthermore, JP2002-3433667A describes a method in which an acidic surface-active agent was used. The intention was to utilize proton conductivity of the surface-active agent even in a case where the acidic surface-active agent remained in the catalyst layer. However, a level of proton conductivity of the surface-active agent is not as high as that of the electrolyte. As a result, the level of proton conductivity of the catalyst layer was reduced.

Further, JPH10-284087A describes an electrode of which a three-phase boundary surface is secured by removed water generated by the electrolytic reaction of a fuel cell. Specifically, an electrode for a polymer electrolyte fuel cell having different kinds of proton electric conductive polymer, and of different equivalent weight (EW) values, is described. The electrode for the polymer electrolyte fuel cell is manufactured by applying a catalyst paste having an electric conductive polymer which is homogeneously dispersed. However, with this catalyst paste a problem occurs in the forming of a catalyst layer.

A need thus exists for an electrode for a polymer electrolyte fuel cell having a catalyst layer that includes a satisfactory number of three-phase boundary surfaces.

### SUMMARY OF THE INVENTION

According to an aspect of the present invention, an electrode for a polymer electrolyte fuel cell includes a polymer electrolyte membrane, and a catalyst layer provided at at least one side of the polymer electrolyte membrane. The catalyst layer is manufactured by application of a catalyst paste. The catalyst paste contains an electrolytic solution, in which electrolytes of different equivalent weights (EWs) are dissolved, or dispersed, and which the electrolytic solution is dissolved, or dispersed in a dispersing medium and a particle supporting a catalyst having electric conductivity, also dissolved, or dispersed, in the dispersing medium. The catalyst paste is manufactured by blending and dispersing an electrolytic solution in which an electrolyte of a low EW is dissolved, or dispersed, into the dispersing medium to a high level of dispersion, and blending and dispersing an electrolytic solution in which an electrolyte of a high EW is dissolved, or dispersed, into the dispersion medium to a low level of dispersion.

According to a further aspect of the present invention, an electrode for a polymer electrolyte fuel cell includes a polymer electrolyte membrane, and a catalyst paste formed on at least one side of the polymer electrolyte membrane. The catalyst paste has an electrolyte of a low EW located on a surface of the catalyst, and has an electrolyte of a high EW located around the electrolyte of a low EW.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a graph indicating measurement results of a particle-size distribution of the dispersed particles in a catalyst paste according to examples of the embodiment of the present invention, and to comparative examples.

FIG. 2 represents a graph indicating measurement results of performance of fuel cells having a catalyst paste according to examples of the embodiment of the present invention and of comparative examples.

### DETAILED DESCRIPTION

An electrode for a polymer electrolyte fuel cell according to the present invention is an electrode for a polymer electrolyte fuel cell having a catalyst layer formed at at least one side of a polymer electrolyte membrane. The catalyst paste is manufactured by applying a catalyst paste including an electrolytic solution in which electrolytes of different EWs are dissolved or dispersed, and a particle-supported catalyst which supports a catalyst and has electric conductivity, both dispersed in a dispersion medium. The catalyst paste is manufactured by mixing an electrolytic solution, in which an electrolyte of a low EW is dissolved or dispersed, and then dispersed to a high level of dispersion, and after that, by mixing an electrolytic solution in which an electrolyte of a high EW is dissolved or dispersed, and then dispersed to a low level of dispersion lower than the high level of dispersion.

In this case, EW indicates an equivalent weight of an ion-exchange group having proton-conductivity. The equivalent weight indicates a weight of an electrolyte per equivalent of ion-exchange groups in a dried condition, in units of g/ew. In other words, the smaller the EW becomes, the greater the potential for ion-exchange (the greater proton conductivity becomes).

In the embodiment of the present invention, the electrolytic solution in which an electrolyte is dissolved or dispersed includes an electrolytic solution in which an electrolyte is completely dissolved, and an electrolytic solution that includes an electrolyte in a condition of colloids. Generally, an electrolyte is dispersed in an electrolytic solution in a condition of colloids of a particle diameter of 3 nm or more. In the embodiment of the present invention, an electrolyte of 3 nm or more in terms of a particle diameter can be dispersed in the electrolytic solution. Further, an electrolyte of a hydrocarbon series can be completely dissolved in the dispersion medium, by reducing molecular weight, or by increasing a sulfonic group.

For the electrode for the polymer electrolyte fuel cell according to the embodiment of the present invention, the catalyst layer is manufactured by applying a catalyst paste including, an electrolytic solution in which electrolytes of different EWs are dissolved or dispersed, and a particle-supported catalyst, that is, a catalyst supported by particles having electric conductivity. The catalyst paste is manufactured by dispersing the electrolytes of different EWs by use of different methods. In other words, in a case where an electrolytic solution in which an electrolyte of a low EW is dissolved or dispersed is dispersed to a high level of dispersion, the electrolyte of a low EW is homogeneously dispersed with the other dispersed particles included in the catalyst paste, particles which support a catalyst, and particles having electric conductivity. An electrolytic solution in which an electrolyte of a low EW is dissolved tends to be easily dissolved, because of low viscosity, and because of low surface tension of the electrolytic solution. Furthermore, because an electrolyte of a low EW can be dispersed to a high level of dispersion, an electrolyte of a low EW can be homogeneously dispersed with the other dispersed particles included in the catalyst paste. At this time, in a case where a porous medium is used as the other dispersed particles, the electrolyte of a low EW infiltrates into a fine porosity of the porous medium. Further, because an electrolyte of a low EW acts as a dispersing agent (stabilizing agent), an electrolyte of a high EW tends to be easily dispersed.

Then, an electric solution in which an electrolyte of a high EW is dissolved or dispersed is further dispersed to a low level of dispersion force, as opposed to high level of dispersion force. Thus, an electrolyte of a high EW is dispersed. Because the dispersion of an electrolyte of a high EW is dispersed to a lower level of dispersion than that in the case of the dispersing of an electrolyte of a low EW, if a porous medium is used as the other dispersed particles, although an electrolyte of a high EW tends to locate around the porous medium, an electrolyte of a high EW does not infiltrate into the porous medium.

Furthermore, the catalyst paste includes the particle-supported catalyst, that is, particles that support the catalyst and have electric conductivity. The catalyst generates a three-phase boundary surface where an electrolytic reaction, that is, a reaction for generating electricity of the polymer electrolyte fuel cell, is induced. Generally, the catalyst is dispersed into the catalyst paste in a condition were the catalyst is supported on the surface of the particle that supports the catalyst, and is made of a porous carbon powder. In other words, an electrolyte of a low EW infiltrates into the fine porosity of the carbon powder in which the catalyst is supported, and the three-phase boundary surface with an inner surface of fine porosity is thus generated. Accordingly, the number of three-phase boundary surfaces is increased.

The electrode for the polymer electrolyte fuel cell according to the embodiment of the present invention includes the catalyst layer manufactured by applying the catalyst paste as described above. Thus, an electrolyte of a low EW is located on the surface of the catalyst, and an electrolyte of a high EW is located around the electrolyte of a low EW. In other words, ions (protons) generated at the three-phase boundary surfaces are immediately transferred by the electrolyte of a low EW to promote a fresh electrolytic reaction. As a result, a high level of performance of the fuel cell can be obtained.

Furthermore, if the electrolyte dispersed into the catalyst paste is only an electrolyte of a low EW, the shape of the catalyst paste applied and dried is substantially changed because of contraction. In other words, the quality of forming the catalyst layer becomes low. On the other hand, the quality of forming catalyst layer is improved by dispersing an electrolyte of a high EW into the catalyst paste.

According to the embodiment of the present invention, dispersion mediums are not particularly limited for dissolving the electrolytic solution in which an electrolyte of different EWs, dispersed into the catalyst paste, is dissolved. Any dispersion medium in which the electrolyte can be used as the dispersion medium. For example, a solvent can be used in which water and ethanol of equivalent volumes are mixed.

Furthermore, a composition rate of the electrolyte in relation to the electrolytic solution depends on the materials of the electrolyte and of the dispersion medium. Therefore, the composition rate can not be determined as a general principle. It is preferable that an electrolyte of from 5% to 20% by weight be contained in an electrolytic solution of 100% by weight.

Furthermore, in a case where the electrolyte that is solved or dispersed in the catalyst paste is only an electrolyte of a low EW, a particle diameter (colloid diameter) of the electrolyte of a low EW in the catalyst paste becomes small. As a result, the catalyst layer manufactured by the catalyst paste becomes excessively fine, a drawback which leads to degradation of gas diffusivity and of water conditions of draining.

It is preferable that an EW of an electrolyte of a low EW be from 700 to 950, and an EW of an electrolyte of a high EW be from 1000 to 1100. When the EW of each type of electrolyte restricted within the range described above, the effect described above can be suitably obtained. Further, it is preferable that a difference between the EW of the electrolyte of a low EW and that of the electrolyte of a high EW be 100 or more.

Further, in a case where the number of kinds of electrolytes of different EWs are two or more, the electrolytes can be classified into the ranges of EW described above. In those circumstances, the electrolytic solution is produced with the use of the electrolyte, and the catalyst paste is produced with the use of the electrolytic solution. In other words, each of the electrolyte of a low EW and the electrolyte of a high EW can include plural electrolytes of different EWs within the confines of each of the ranges described above.

It is preferable that the catalyst paste includes an electrolyte of a low EW in a weight ratio of 1 or less in relation to an electrolyte of a high EW. The weight ratio of the electrolyte of a low EW and the electrolyte of a high EW is indicated by (a weight of the electrolyte of a low EW dispersed in the catalyst paste)/(a weight of the electrolyte of a high EW dispersed in the catalyst paste). In a case where the weight ratio becomes 1 or less, while the quality of the catalyst layer manufactured by application of the catalyst paste can be maintained, a degree of dispersion of the electrolyte can be enhanced. As a result, the performance of a catalyst paste obtained by the catalyst paste manufactured can be enhanced. It is more preferable that the weight ratio be 0.5 or less. It is further more preferable that the weight ratio be in a range from 0.1 to 0.4.

At the time of manufacturing the catalyst paste, a high level of dispersion for the electrolytic solution for dissolving or dispersing the electrolyte of a low EW means a dispersing process for the purpose of making an electrolyte of a low EW into finer particles. Further, a low level of dispersion of the electrolytic solution for dissolving or dispersing an electrolyte of a high EW means a dispersing process in which a lower dispersing force is used than that of a high level of dispersion appropriate for the purpose of homogeneously mixing the electrolyte. In other words, a high level of dispersion makes a high degree of impact on an electrolyte particle, and a low level of dispersion makes a low degree of impact on an electrolyte particle. Therefore, even in a case where identical dispersion equipment is used, a dispersing process in a condition where a degree of energy applied to the electrolyte particle is high is tantamount to a high level of dispersion, and a dispersion process in a condition where a degree of energy applied to the electrolyte particle is low is tantamount to a low level of dispersion. The boundary between high level dispersion and low level dispersion can not be determined exactly because this boundary depends on the various kinds of electrolyte particle, and the like. For example, the boundary between high level dispersion and low level dispersion can be determined by a peripheral speed (for example, a dispersion of 10 m/s or more in peripheral speed is equivalent to a high level of dispersion) in the case of dispersion equipment such as a bead mill of a media type; by pressure (for example, 3 MPa or more in pressure is tantamount to a high level of dispersion) in the case of a dispersing equipment utilizing high pressure such as a jet mill; or by a peripheral speed or rotation frequency (for example, 10000 rpm or more in terms of a rotation frequency is tantamount to a high level of dispersion) in the case of dispersing equipment utilizing jigs such as a blade which generates homogenization or cavitation.

For the electrode for a polymer electrolyte fuel cell according to the embodiment of the present invention, materials of the catalyst paste, other than the electrolytes of different EWs, are not particularly limited, and conventional materials can be utilized.

As the catalyst paste, a paste made of carbon powder particles supporting a catalyst metal such as Pt (catalyst-supporting carbon powder), and an electrolyte made of an ion-conductive polymer, both mixed into a solvent such as water or alcohol, can be utilized. Further, in appropriate circumstances, carbon micropowder processed by a fluorocarbon resin for the use as a water repellent, or a water repellent agent, can be contained in the catalyst paste.

Further, as a polymer electrolyte membrane on which the catalyst paste is formed, a conventional material can be used. As the polymer electrolyte membrane, a perfluoro sulfonic acid membrane, represented by Nafion membrane manufactured by DuPont Corporation, or a hydrocarbon series membrane manufactured by Hoechst Corporation, a partially fluorinated polymer membrane, or the like, can be used.

Further, it is preferable that a diffusion layer provide on a counter surface of a boundary surface between the catalyst layer and the polymer electrolyte membrane. A water repellent porous carbon sheet can be utilized for manufacturing the diffusion layer.

The catalyst layer of the electrode of the polymer electrolyte fuel cell according to the embodiment of the present invention can be manufactured from the catalyst paste by use of a conventional method. In other words, the catalyst layer can be formed by applying the catalyst paste onto the polymer electrolyte membrane, and by the drying it. The catalyst layer can also be formed by applying the catalyst paste onto a fluorocarbon resin film, a polytetrafluoroethylene (PTFE) or other such film for forming the diffusion layer, dried, and then bonded onto the polymer electrolyte membrane.

The manufacturing method for the electrode for the polymer electrolyte fuel cell according to the embodiment of the present invention is not limited to a particular method. For example, the manufacturing method described bellow can be used.

First, an electrolytic solution in which an electrolyte of a low EW is solved or dispersed, a particle supporting a catalyst having electric conductivity, and a dispersion medium are weighed and mixed. The mixed solution is homogenized by use of a homogenizer such as a sand mill. A paste containing the electrolyte of a low EW which had been dispersed at a high level of dispersion is produced.

Next, an electrolytic solution in which an electrolyte of a high EW is dissolved and dispersed is added to the paste, and homogenized by use of planetary homogenizing and deforming equipment. By means of the process of homogenizing, the catalyst paste was produced.

The produced catalyst paste is applied to an item such as the polymer electrolyte membrane, PTFE, or the diffusion layer, and is then dried. The dried catalyst paste forms the catalyst layer.

A polymer electrode membrane and a gas diffusion layer are bonded to the dried catalyst paste, and a membrane electrode assembly thus formed. A separator having a gas flowing path is provided onto each side of the membrane electrode assembly, and a fuel cell is thus formed.

An example according to the embodiment of the present invention will now be explained.

As an example according to the embodiment of the present invention, an electrode for a polymer electrolyte fuel cell is produced at first.

### FIRST EXAMPLE

First, a carbon powder supporting Pt of 46% by weight (manufactured by Tanaka Kikinzoku Kogyo, T10E50E), in a weight ratio of 6.3, a polymer electrolytic solution containing an electrolyte component of 5% by weight (an ion-exchange resin solution, manufactured by Asahi Kasei, SS-900/05, solvent: a mixture of equivalent volume of water and ethanol, EW:900), in a weight ratio of 16.9, and ion-exchange water, in a weight ratio of 26.2, were weighed, and mixed well with a sand mill. Thus, a material paste was produced. The sand mill utilized includes a zirconia ball of 5 mm in diameter. The sand mill was operated for two hours for mixing at 15 m/s in terms of peripheral speed.

Next, a polymer electrolytic solution containing an electrolytic component of 5% by weight (ion-exchange resin solution, manufactured by Asahi Kasei Corporation, SS-1100/05, solvent: a mixture of equivalent volume of water and ethanol, EW:1100), in a weight ratio of 50.6, was added to the material paste. Then, after the polymer electrolytic solution was added, the material paste, was homogenized and deformed with planetary homogenizing and deforming equipment (manufactured by Thinky Corporation, AR-360M) in conditions where a material container of the equipment was rotated at 600 rpm, and at the same time, revolved at 2000 rpm, for a duration of 10 minutes. A catalyst paste was thus produced.

The catalyst paste produced was applied onto a PTFE by use of an applicator having a gap of 150 μm. An area on which the catalyst paste was applied was 50 cm². The catalyst paste applied was retained in a condition of atmospheric pressure and a temperature of 70° C. for a duration of one hour. The catalyst paste, which had been applied on the PTFE and retained, was next dried.

The dried catalyst paste was detached from the PTFE, and bonded to the polymer electrolyte membrane. The polymer electrolyte membrane (made by DuPont corporation, Nafion 112, 50 μm of a membrane thickness) was bonded to the dried catalyst paste by pressing in a thickness direction in conditions of a temperature of 150° C., and 10 MPa in terms of pressing pressure. The polymer electrolyte membrane and the dried catalyst paste were arranged in a thickness direction. The dried catalyst paste was similarly also bonded to the other surface of the polymer electrolyte membrane by pressing. In this case, the dried catalyst pastes were simultaneously bonded to both sides of the electrolyte membrane. In other words, the pressing was performed in a condition where the dried catalyst pastes were provided to both sides of the electrolyte membrane.

After that, in a similar manner to the case of the bonding of the dried catalyst paste, a water-repellent carbon sheet was bonded by pressing to each side of the layers of the polymer electrolyte membrane and the dried catalyst paste in conditions of a temperature of 140° C., and 8 MPa in terms of pressing pressure. The water-repellent carbon sheet was produced by impregnating the carbon sheet (manufactured by Toray, TGP-H-60) with a dispersion solution of a carbon black (manufactured by Cabot, VULCAN XC-72R) and a water-repellent agent (manufactured by Daikin Industries, Ltd., Polyflon D1), and by baking the carbon sheet impregnated in a condition of 380° C. for a duration of one hour. In this case, the water-repellent carbon sheet was also simultaneously bonded in a similar manner to the case of the bonding of the dried catalyst paste, by pressing to each side of the layers of the polymer electrolyte membrane and the dried catalyst paste.

Thus, an MEA (a membrane electrode assembly) including the catalyst layer according to the embodiment of the present invention was manufactured.

A ratio of (weight of the electrolyte of low EW)/(weight of the electrolyte of high EW) of the catalyst paste according to the embodiment of the present invention was 0.3 (1/3).

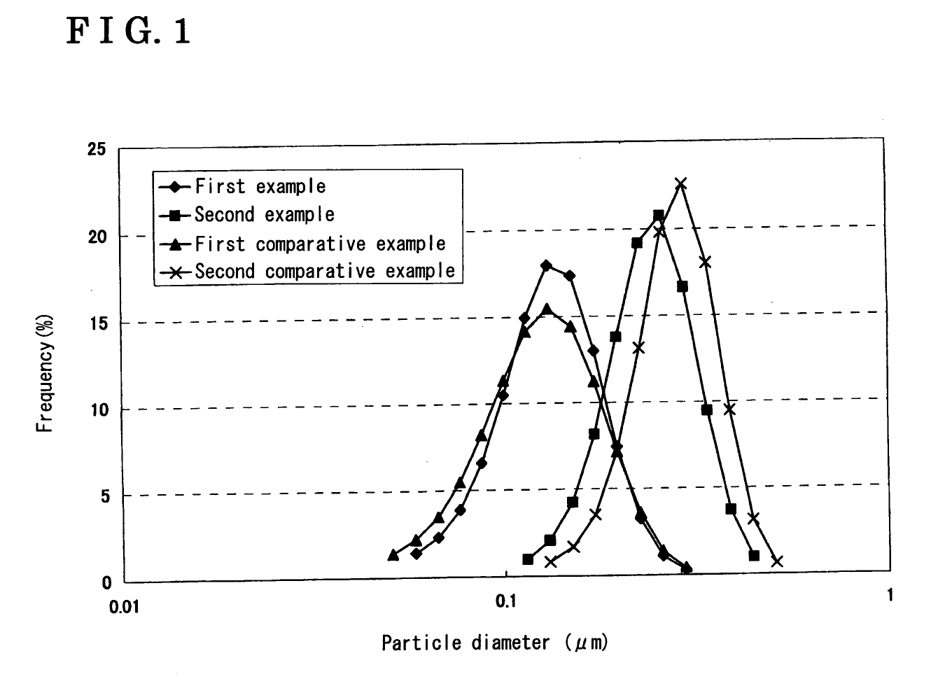

Further, by means of measurement performed with a particle-size distribution analyzer (manufactured by Horiba, Ltd., LB-550), the median of diameter of the dispersed particles of the catalyst paste was established to be 0.1239 μm. FIG. 1 represents the measurement results of the particle-size distribution.

### SECOND EXAMPLE

The manufacturing method was basically similar to the first example except in terms of the amounts of the two kinds of polymer electrolyte solutions added and dispersed into the catalyst paste. In the example, the materials used were the same as those used for the first example, unless specifically indicated to the contrary.

First, carbon powder supporting 46% by weight of Pt, by weight ratio of 6.3, a polymer electrolytic solution (EW:900) having 5% by weight of electrolytic component, in a weight ratio of 33.7, and ion-exchange water, in a weight ratio of 26.2, were weighed, and sufficiently mixed with the use of a sand mill. Thus, a material paste was produced. The sand mill including zirconia balls of 5 mm in a diameter was operated for a duration of two hours in conditions of 15 m/s in terms of peripheral speed.

Next, a polymer electrolytic solution (EW:1100) containing an electrolytic component of 5% by weight, in a weight ratio of 33.8, was added to the material paste, and the material paste to which the polymer electrolytic solution (EW:1100) had been added was mixed with the planetary homogenizing and deforming equipment in a condition where a material container of the equipment was rotated at 600 rpm, and at the same time, revolved at 2000 rpm, for a duration of 10 minutes. Thus, the catalyst paste was produced.

Thus, by use of an identical to that in the first example, an MEA having the catalyst layer according to the second example was manufactured from the catalyst paste produced.

The ratio of (weight of the electrolyte of low EW)/(weight of the electrolyte of high EW) of the catalyst paste, which was produced according to the second example, was 1.0 (1/1).

A median of a diameter of dispersed particles in the catalyst paste was 0.2281 μm. Particle-size distribution measured is also represented in FIG. 1.

### FIRST COMPARATIVE EXAMPLE

In the first comparative example, the manufacturing method used was the same as that used in the first example, except insofar that the polymer electrolytic solution of a high EW was not added, and that the homogenizing, by use of the planetary homogenizing and deforming equipment, was not performed. Moreover, the materials used in the first comparative example were the same as those used in the first example, unless specifically indicated to the contrary.

First, a carbon powder supporting Pt of 46% by weight, in a weight ratio of 6.3, a polymer electrolytic solution (EW:900) containing an electrolytic component of 5% by weight, in a weight ratio of 67.5, and ion-exchanged water, in a weight ratio of 26.2, were weighed, and adequately mixed with a sand mill. Thus, a catalyst paste was produced. The sand mill having a zirconia ball of 5 mm in diameter was operated for a duration of two hours in conditions of 15 m/s in terms of peripheral speed.

MEA having the catalyst layer according to the first comparative example was manufactured from the catalyst paste, which had been produced by use of a method identical to that used in the first example.

A median of a diameter of dispersed particles of the catalyst paste, which was produced according to the comparative example, was 0.1184 μm. Particle-size distribution measured is also represented in FIG. 1.

### SECOND COMPARATIVE EXAMPLE

According to the second comparative example, the manufacturing method used was identical to that used in the first comparative example, except insofar that an electrolytic solution of a high EW was used instead of a polymer electrolytic solution of a low EW, and that the homogenizing, by use of planetary homogenizing and deforming equipment, was not performed. Additionally, materials used in the second comparative example were the same as in the first example, unless specifically indicated to the contrary.

First, a carbon powder supporting Pt of 46% by weight, in a weight ratio of 6.3, a polymer electrolytic solution (EW:1100) containing an electrolytic component of 5% by weight, in a weight ratio of 67.5, and ion-exchange water, in a weight ratio of 26.2, were weighed, and adequately mixed with a sand mill. A catalyst paste was thus produced. The sand mill having zirconia balls of 5 mm in diameter was operated for a duration of two hours in conditions of 15 m/s in terms of peripheral speed.

An MEA having a catalyst layer according to the second comparative example was produced from the catalyst paste produced by use of the same method as that used in the first example.

A median of a diameter of particles dispersed in the catalyst paste, which was produced according to the second comparative example, was 0.2647 μm. Particle-size distribution measured is also represented in FIG. 1.

Evaluation

Next, for evaluating each of the MEAs having the catalyst layer according to each of the examples according to the embodiment of the present invention and the comparative examples, a fuel cell was assembled. Then, the relation between electricity and voltage of each of the assembled fuel cells was measured.

For every MEA according to the examples and the comparative examples, separators having a gas flowing path were provided on both sides of the MEA for manufacturing a fuel cell of a single MEA.

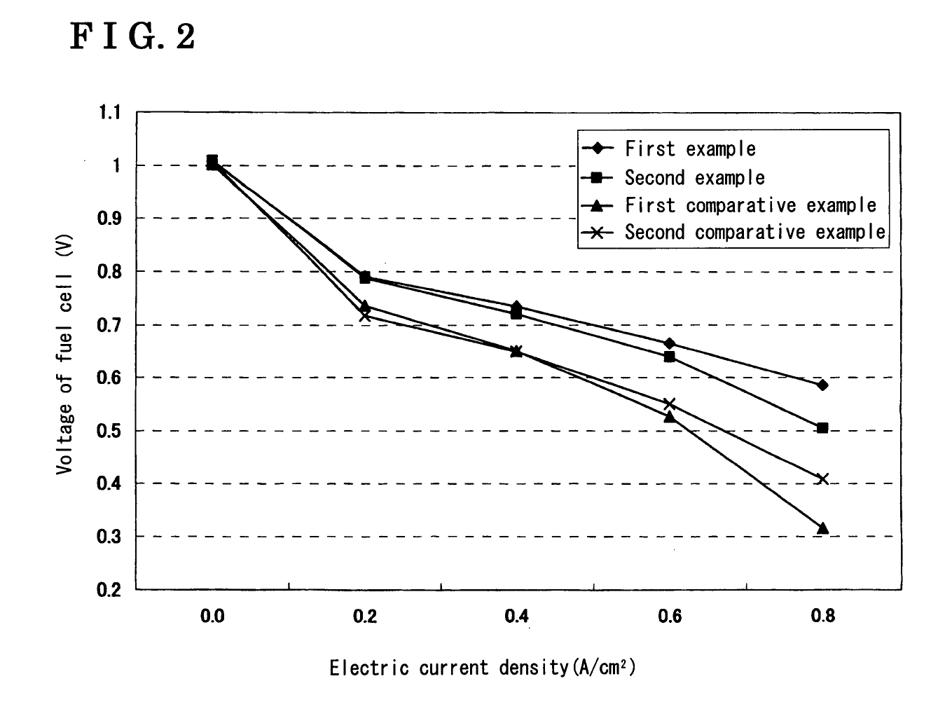

The relation of electric current and voltage of the fuel cells assembled was measured. Hydrogen gas was supplied to a fuel side electrode, and air was supplied to an air side electrode. Moisture was added to each of the hydrogen and the air supplied to each electrode at a dew point of 60° C. When gas was supplied to the fuel cell, the temperature of the fuel cell was retained at 80° C., utilization of hydrogen gas was 90%, and utilization of air was 40%. The results measured are shown in FIG. 2.

As is shown in FIG. 2, the fuel cell formed from the MEA having the catalyst layer according to the examples results in a higher voltage of fuel cell than that of the fuel cell formed from the catalyst layer according to the comparative examples. In other words, dispersion of two kinds of the polymer electrolytic solutions having electrolytic components of different EWs by use of different dispersing methods results in a higher performance of the fuel cell.

Specifically, a polymer electrolytic solution having the electrolytic component of a low EW has electrolytic components that, by means of dispersing with the use of a sand mill, infiltrate into fine porosities located at the surface of the carbon particles supporting Pt. Thus, the electrolytic component is located around the Pt supported on the surface of the fine porosities. In this condition, the catalyst paste is dried. Thus, in the case of the catalyst layer according to the examples, the electrolyte of a low EW (and of a high ion conductivity) is located around Pt, and thus a three-phase boundary surface is manufactured. As a result of this, the fuel cells including a MEA with the catalyst layer according to the examples of the embodiment of the present invention exhibited a high level of performance.

Additionally, in the examples described above, the catalyst paste was applied onto the PTFE. However, the catalyst paste can also be applied onto a fluorine resin film. Furthermore, the catalyst paste can be applied onto the polymer electrolyte membrane. When the catalyst paste is applied onto the polymer electrolyte membrane, the catalyst layer bonded to the polymer electrolyte membrane so as to form a single member can be obtained.

According to an aspect of the present invention, an electrode for a polymer electrolyte fuel cell having a catalyst layer containing a large number of three-phase boundary surfaces can be obtained by controlling the level of the dispersion of the catalyst paste when the catalyst layer is manufactured.

In other words, the electrode for a polymer electrolyte fuel cell according to the aspect of the present invention includes a catalyst paste formed at at least one side of the polymer electrolyte membrane. For manufacturing the catalyst layer, a catalyst paste is applied, a catalyst paste containing an electrolytic solution, into which electrolytes of different EWs are dissolved or dispersed, and catalyst supporting particles having electric conductivity are dissolved or dispersed, into a dispersion medium. For manufacturing the catalyst paste, an electrolytic solution into which an electrolyte of a low EW is dissolved or dispersed, is mixed into the dispersion medium, and dispersed to a high level, and after that, the electrolytic solution into which an electrolyte of a high EW is dissolved or dispersed, is mixed and dispersed to a low level, in other words, with a lower degree of dispersion force than that required at a high level of dispersion.

According to a further aspect of the present invention, for manufacturing an electrode for a polymer electrolyte fuel cell, an electrolytic solution, in which an electrolyte of a low EW is dissolved, is dispersed to a high level. A homogeneous solution, in which the electrolyte of a low EW and other dispersed particles are dispersed, is formed. Further, the electrolytic solution, in which the electrolyte of a low EW is dissolved, is dispersed to a high level of dispersion. Thus, the degree of dispersion can be enhanced. As a result, an electrode for a polymer electrolyte fuel cell according to the aspect of the present invention can have a catalyst layer having a sufficient number of three-phase boundary surfaces.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An electrode for a polymer electrolyte fuel cell, comprising:
a polymer electrolyte membrane; and
a catalyst layer provided at at least one side of the polymer electrolyte membrane,
the catalyst layer manufactured by application of a catalyst paste;
the catalyst paste, containing:
an electrolytic solution, in which electrolytes of different equivalent weights (EWs) are dissolved, or dispersed, and which the electrolytic solution is dissolved, or dispersed in a dispersing medium; and
a particle supporting a catalyst having electric conductivity, also dissolved, or dispersed, in the dispersing medium;
the catalyst paste, manufactured by:
blending and dispersing an electrolytic solution in which an electrolyte of a low EW is dissolved, or dispersed, into the dispersing medium to a high level of dispersion, and blending and dispersing an electrolytic solution in which an electrolyte of a high EW is dissolved, or dispersed, into the dispersion medium to a low level of dispersion.

2. The electrode for a polymer electrolyte fuel cell according to claim 1, wherein
an EW of the electrolyte of a low EW is within a range from 700 to 950, and an EW of the electrolyte of a high EW is within a range from 1000 to 1100.

3. The electrode for a polymer electrolyte fuel cell according to claim 1, wherein
the catalyst paste contains the electrolyte of a low EW in a weight ratio of 1 or less in relation to the electrolyte of a high EW.

4. The electrode for a polymer electrolyte fuel cell according to claim 1, wherein
the catalyst paste contains the electrolyte of a low EW in a weight ratio of 0.5 or less in relation to the electrolyte of a high EW.

5. The electrode for a polymer electrolyte fuel cell according to claim 1, wherein
the catalyst paste contains the electrolyte of a low EW in a weight ratio of from 0.1 to 0.4 in relation to the electrolyte of a high EW.

6. The electrode for a polymer electrolyte fuel cell according to claim 1, wherein
the particle for supporting the catalyst is a catalyst-supporting carbon powder.

7. The electrode for a polymer electrolyte fuel cell according to claim 1, wherein
an EW of the electrolyte of a high EW is greater than an EW of the electrolyte of a low EW by 100 or more.

8. The electrode for a polymer electrolyte fuel cell according to claim 1, wherein
the electrolyte is contained in the electrolytic solution in a weight ratio of from 5 to 20%.

9. The electrode for a polymer electrolyte fuel cell according to claim 1, wherein
the high level of dispersion is performed with a sand mill.

10. The electrode for a polymer electrolyte fuel cell according to claim 1, wherein
the low level of dispersion is performed with planetary homogenizing and deforming equipment.

11. An electrode for a polymer electrolyte fuel cell, comprising:
a polymer electrolyte membrane; and
a catalyst layer provided on at least one side of the polymer electrolyte membrane,
the catalyst layer having an electrolyte of a low EW located on a surface of the catalyst, and having an electrolyte of a high EW located around the electrolyte of a low EW.

12. The electrode for a polymer electrolyte fuel cell according to claim 11, wherein
an EW of the electrolyte of a low EW is within a range from 700 to 950, and an EW of the electrolyte of a high EW is within a range from 1000 to 1100.

13. The electrode for a polymer electrolyte fuel cell according to claim 11, wherein
the EW of the electrolyte of a high EW is greater than the EW of the electrolyte of a low EW by 100 or more.

14. The electrode for a polymer electrolyte fuel cell according to claim 11, wherein
the catalyst layer manufactured by application of a catalyst paste,
the catalyst paste, containing:
an electrolytic solution, in which electrolytes of different EWs are dissolved or dispersed, and which the electrolytic solution is dissolved or dispersed in a dispersing medium; and
a particle supporting a catalyst having electric conductivity, also dissolved, or dispersed in the dispersing medium;
the catalyst paste, manufactured by:
blending and dispersing the electrolytic solution, in which the electrolyte of a low EW is dissolved, or dispersed, into the dispersing medium to a high level of dispersion; and blending and dispersing the electrolytic solution, in which the electrolyte of a high EW is dissolved, or dispersed, into the dispersion medium to a low level of dispersion.

15. The electrode for a polymer electrolyte fuel cell according to claim 14, wherein
the catalyst paste contains the electrolyte of a low EW in a weight ratio of 1 or less in relation to the electrolyte of a high EW.

16. The electrode for a polymer electrolyte fuel cell according to claim 14, wherein
the catalyst paste contains the electrolyte of low EW by weight ratio of 0.5 or less to the electrolyte of a high EW.

17. The electrode for a polymer electrolyte fuel cell according to claim 14, wherein
the particle for supporting a catalyst is a catalyst-supporting carbon powder.

18. The electrode for a polymer electrolyte fuel cell according to claim 14, wherein
the electrolyte is contained in the electrolytic solution in a weight ratio of from 5 to 20%.

19. The electrode for a polymer electrolyte fuel cell according to claim 14, wherein
the high level of dispersion is performed with a sand mill.

20. The electrode for a polymer electrolyte fuel cell according to claim 14, wherein
the low level of dispersion is performed with planetary homogenizing and deforming equipment.
